(19) United States
(12) Patent Application Publication
(10) Pub. No.: US 2006/0283252 A1
(43) Pub. Date: Dec. 21, 2006

(54) Passive acoustic wave sensor system

(75) Inventors: James ZT Liu, Belvidere, IL (US); Michael L. Rhodes, Richfield, MN (US); Aziz Rahman, Sharon, MA (US)

Correspondence Address: Kris T. Fredrick, Attorney, Intellectual Property;Honeywell International, Inc., 101 Columbia Rd., P.O. Box 2245, Morristown, NJ, 07962, US

(73) Assignee: Honeywell International Inc.

(21) Appl. No.: 11/157,103

(22) Filed: Jun. 17, 2005

(51) Int. Cl. G01N 29/00

(52) U.S. Cl. 73/649

(57) ABSTRACT

A passive acoustic wave sensor system for monitoring the quality of liquids, such as engine oil, is disclosed. The sensor system has an acoustic wave sensing device for generating a propagating acoustic wave and for detecting changes in frequency or other propagation characteristics of the acoustic wave caused by acousto-electric interactions between the liquid and the wave at an interactive region of the device. An antenna is integrated in the sensing device for receiving an interrogation signal and for transmitting the output response of the sensing device. The output response can be analyzed to determine the conductivity, pH or other electrical characteristics of the liquid. One or more reference devices may be utilized to compensate for mechanical effects of the liquid and temperature or other environmental effects. The sensing and reference devices can be configured as SH-SAW, SH-APM, FPM devices or other acoustic wave devices.

### TECHNICAL FIELD

Embodiments are generally related to sensing devices, systems and methods and, in particular, to acoustic wave sensor devices, systems and methods. Embodiments are additionally related to passive acoustic wave sensor devices, such as, for example, surface acoustic wave (SAW) devices and sensors. Embodiments are additionally related to sensors for monitoring the electrical properties of oil and other liquids. Additionally, embodiments are related to detection of the pH of engine oil contained inside an oil filter system of a vehicle.

### BACKGROUND OF THE INVENTION

Acoustic wave sensors are utilized in a variety of sensing applications, such as, for example, temperature and/or pressure sensing devices and systems. Acoustic wave devices have been in commercial use for over sixty years. Although the telecommunications industry is the largest user of acoustic wave devices, they are also used for sensor applications, such as in chemical vapor detection. Acoustic wave sensors are so named because they use a mechanical, or acoustic, wave as the sensing mechanism. As the acoustic wave propagates through or on the surface of the material, any changes to the characteristics of the propagation path affect the velocity and/or amplitude of the wave.

Changes in acoustic wave characteristics can be monitored by measuring the frequency or phase characteristics of the sensor and can then be correlated to the corresponding physical quantity or chemical quantity that is being measured. Virtually all acoustic wave devices and sensors utilize a piezoelectric crystal to generate the acoustic wave. Three mechanisms can contribute to acoustic wave sensor response, i.e., mass-loading, visco-elastic and acousto-electric effect. The mass-loading of chemicals alters the frequency, amplitude, and phase and Q value of such sensors. Most acoustic wave chemical detection sensors, for example, rely on the mass sensitivity of the sensor in conjunction with a chemically selective coating that absorbs the vapors of interest resulting in an increased mass loading of the SAW sensor.

Examples of acoustic wave sensors include acoustic wave detection devices, which are utilized to detect the presence of substances, such as chemicals, or environmental conditions such as temperature and pressure. An acoustical or acoustic wave (e.g., SAW/BAW) device acting as a sensor can provide a highly sensitive detection mechanism due to the high sensitivity to surface loading and the low noise, which results from their intrinsic high Q factor. Surface acoustic wave (SAW/SH-SAW) and amplitude plate mode (APM/SH-APM) devices are typically fabricated using photolithographic techniques with comb-like interdigital transducers (IDTs) placed on a piezoelectric material. Surface acoustic wave devices may have a delay line, a filter or a resonator configuration. Bulk acoustic wave devices are typically fabricated using a vacuum plater, such as those made by CHA, Transat or Saunder. The choice of the electrode materials and the thickness of the electrode are controlled by filament temperature and total heating time. The size and shape of electrodes are defined by proper use of masks.

Based on the foregoing, it can be appreciated that acoustic wave devices, such as a surface acoustic wave resonator (SAW-R), surface acoustic wave filter (SAW-filter), surface acoustic wave delay line (SAW-DL), surface transverse wave (STW), bulk acoustic wave (BAW), can be utilized in various sensing measurement applications.

One promising application for micro-sensors involves oil filter and oil quality monitoring. Diesel engines are particularly hard on oil because of oxidation from acidic combustion. As the oil wears, it oxidizes and undergoes a slow build-up of total acids number (TAN). A pH sensor is capable of direct measurement of TAN and an indirect measurement of total base number (TBN), providing an early warning of oil degradation due to oxidation and excess of water. The acids and water build-up is also related to the viscosity of the oil. Low temperature start-ability, fuel economy, thinning or thickening effects at high and/or low temperatures, along with lubricity and oil film thickness in running automotive engines are all dependent upon viscosity. Frequency changes in viscosity have been utilized in conventional oil detection systems. The frequency changes caused by small changes in viscosity of highly viscous liquids, however, are very small. Because of the highly viscous loading, the signal from a sensor oscillator is very “noisy” and the accuracy of such measurement systems is very poor. Moreover, such oscillators may cease oscillation due to the loss of the inductive properties of the resonator.

Based on the foregoing it is believed that a solution to the problems associated with conventional oil and other liquid micro-sensing applications may involve acoustic wave devices. Acoustic wave sensors can detect both mechanical and electrical property changes that include variations in mass, elasticity, dielectric properties and conductivity (e.g., electronic, ionic and thermal). This is because the acoustic wave that probes the medium of interest has both mechanical displacements and an electric field. Therefore, it is believed that acoustic wave sensors may well be suited for monitoring the electrical properties of liquids, such as engine oil, as indicated by the embodiments described herein.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved sensing devices and applications.

It is another aspect of the present invention to provide for an acoustic wave sensor for sensing liquids.

It is a further aspect of the present invention to provide for a wireless passive acoustic wave sensor, such as, for example, a shear horizontal surface acoustic wave (SH-SAW) device, for sensing the electrical properties of liquids.

It is an additional aspect of the present invention to provide a pH sensor, which can be utilized in automotive applications (e.g. as a sensor to monitor oil quality).

The aforementioned aspects of the invention and other objectives and advantages can now be achieved as described herein. Wireless passive acoustic wave sensor systems and methods are disclosed.

The sensor system generally includes an acoustic wave sensing device having a piezoelectric substrate and an antenna integrated in the sensing device. One or more transducers are coupled to the substrate and antenna. The transducer(s) is/are adapted and arranged to transform the interrogation signal into an acoustic wave propagating in the device and to transform the propagating wave into a response for transmission by the antenna. The device includes an electrically open interactive region arranged in a path of the wave such that a liquid disposed at or adjacent to the interactive region can interact acousto-electrically with the propagating wave. The sensing device can reply to the interrogation signal by transmitting a response in which changes in frequency, phase or other propagation characteristics caused by acousto-electric interaction between the liquid and wave are measurable to evaluate the conductivity, pH or other electrical properties of the liquid.

By integrating the antenna into the sensing device, the sensing device is operable passively without the need for directly providing the sensing device with a power supply or oscillator. Furthermore, the sensor system can detect and monitor the electrical properties of the liquid, such as pH or conductivity, remotely.

The sensing device can be configured either as a resonator, a filter or as a delay line device.

When the sensing device is configured as a resonator, the sensing device includes at least one reflector for reflecting the propagating wave. The interactive region is formed in the resonator cavity between the reflector(s) and transducer(s). The resonator can be configured as a two-port resonator, i.e., a filter, in which an input interdigital transducer (IDT) and output IDT are formed on the substrate between a pair of reflectors. Each IDT is electrically coupled to an antenna. In this arrangement the substrate surface between the input and output IDTs is electrically open forming the interactive region.

When the sensing device is configured as a delay line device, the sensor can be configured as a two-port delay line device in which an input IDT and an output IDT are formed spaced apart and an electrically open substrate surface therebetween serves as the interactive region. Alternatively, the sensing delay line device can be configured as a reflective delay line device in which the delay line is provided by a single IDT spaced apart from one or more reflectors.

Each reflector may comprise at least one metallic member, such as metallic stripe, formed on the substrate spaced from the transducer(s) or may comprise an edge of the substrate which edge is substantially perpendicular to the propagation path of the wave.

The sensing device can be configured such that the interrogation signal is transformed by the transducer(s) into any type of acoustic wave having a surface wave component which is capable of interacting acousto-electrically with the liquid, such as for example, shear-horizontal type modes which may be a shear-horizontal surface acoustic wave (SH-SAW), shear-horizontal acoustic plate mode (SH-APM), flexural plate mode (FPM) also known as Lamb wave, and/or a Love wave.

The sensor system can include an interrogation unit for transmitting the interrogation signal and for receiving the response transmitted from the sensing device. The interrogation unit can include electronics for gating the received response in the time domain to differentiate between the interrogation signal and the response of the sensing device.

The sensor system can include an oscillator circuit coupled to the interrogation unit such that the sensing device is part of a feedback loop of the oscillator circuit. A frequency counter can be connected to the oscillator circuit and can be controlled by a processor for measuring changes in the oscillation frequency or transient response caused by interaction between the liquid and the propagating wave.

The sensor system can include at least one acoustic reference device formed on the same substrate and coupled to the antenna. As in the case of the sensing device, each reference device can have one or more transducers, such as IDTs, coupled to the substrate and antenna. The transducer(s) is/are adapted and arranged to transform the interrogation signal into an acoustic reference wave propagating in the device and to transform the propagating wave into a response for transmission by the antenna. Each reference device includes a reference region arranged in a path of the wave such that liquid disposed at or adjacent the reference region causes interactions, other than acousto-electric interactions, with the reference wave. Each reference device can reply to the interrogation signal by transmitting a response in which mechanical interactions of the liquid with the reference wave are measurable to evaluate the mechanical effects of the liquid on the reference wave. When the same liquid is disposed at or adjacent both the interactive and reference regions, reference and sensing devices reply to the interrogation signal by transmitting responses in which changes in frequency, phase or other propagation characteristics caused by the acousto-electrically effects of the liquid are separable from changes caused by mechanical effects of the liquid to evaluate the conductivity, pH or other electrical properties of the liquid.

The sensing device and reference device(s) can be formed on the same side of the substrate such that the interactive and reference regions can contact the liquid under analysis. The reference device(s) and sensing device can include conductive layers disposed on the substrate surface and coupled to the IDTs of the devices. The conductive layer of the sensing device can have an opening defined therein forming an electrically open surface which serves as the sensing device interactive region whereas the conductive layer of each reference device forms an electrically closed surface which serves as the reference device reference region. Utilizing conductive layers in both the sensing device and the reference device(s) allows fabrication of all the devices as a single unit using a small single die. Furthermore, both sensing and reference devices can respond to similar mechanical effects of the liquid and other environmental effects, such as temperature, in a similar manner facilitating compensation of these effects. Alternatively, only each reference device has a conductive layer and the substrate surface between the IDTs of the sensing device can serve as the sensing device interactive region.

When APM or FPM wave modes are utilized, the sensing device and reference device(s) can be formed on the same side of the substrate, or alternatively, the reference device(s) can be formed on an opposite side of the substrate to the sensing device. In the latter arrangement, the sensing device interactive region is arranged to contact liquid whereas the reference device reference region is isolated from the liquid by the substrate. By isolating the reference region from the liquid, layers used to define the interactive region and reference region may be either conductive, such as metallic layers, non-conductive or semi-conductive. Alternatively, open surfaces on opposite sides of the substrate can function as the interference region and reference region(s), respectively.

In one particular embodiment, the sensor system includes an acoustic wave sensing device and a pair of acoustic wave reference devices formed on the same substrate and coupled to the antenna. The reference devices are arranged at a specific angle relative to one another such that the acoustic reference waves of each device have differing temperature or other environmental dependence. When the same liquid is disposed at or adjacent both the interactive region and reference regions, the sensing device and reference devices can reply to the interrogation signal by transmitting responses in which changes in frequency, phase or other propagation characteristics of the waves caused by acousto-electric effects of the liquid, mechanical effects of the liquid, and temperature or other environmental effects are separable from one another to enable temperature or other environmental compensation of the measurements of the conductivity, pH or other electrical properties of the liquid.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a passive acoustic wave sensor system having a SH-SAW resonator sensing device which can be implemented in accordance with a preferred embodiment;

FIG. 2 illustrates the principle of operating the passive acoustic wave sensor system of FIG. 1 using an interrogation unit;

FIG. 3 illustrates a typical oscillation circuit including an amplifier and processing circuitry for analyzing the output response of the sensing device of FIG. 1.

FIG. 4 illustrates a passive acoustic wave sensor system having SH-SAW resonator sensing and reference devices in accordance with a second embodiment;

FIG. 5(a) illustrates a passive acoustic wave sensor system having a SH-SAW resonator sensing device and a pair of SH-SAW resonator reference devices in accordance with a third embodiment;

FIG. 5(b) illustrates an oil filter system in which the passive acoustic wave sensor system of FIG. 5(a) can be applied for monitoring engine oil quality;

FIG. 6(a) illustrates a front perspective view of a passive acoustic wave sensor system having SH-APM resonator sensing and reference devices in accordance with a fourth embodiment;

FIG. 6(b) illustrates a rear perspective view of the passive acoustic wave sensor system shown in FIG, 6a;

FIG. 7(a) illustrates a front perspective view of a passive sensor system having FPM sensing and reference devices in accordance with another embodiment;

FIG. 7(b) illustrates a rear perspective view of the passive sensor system of FIG. 7(a); and

FIG. 8 illustrates a plan view of a passive sensor system having a sensing and reference devices configured as SH-SAW delay-line devices according to yet another embodiment.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

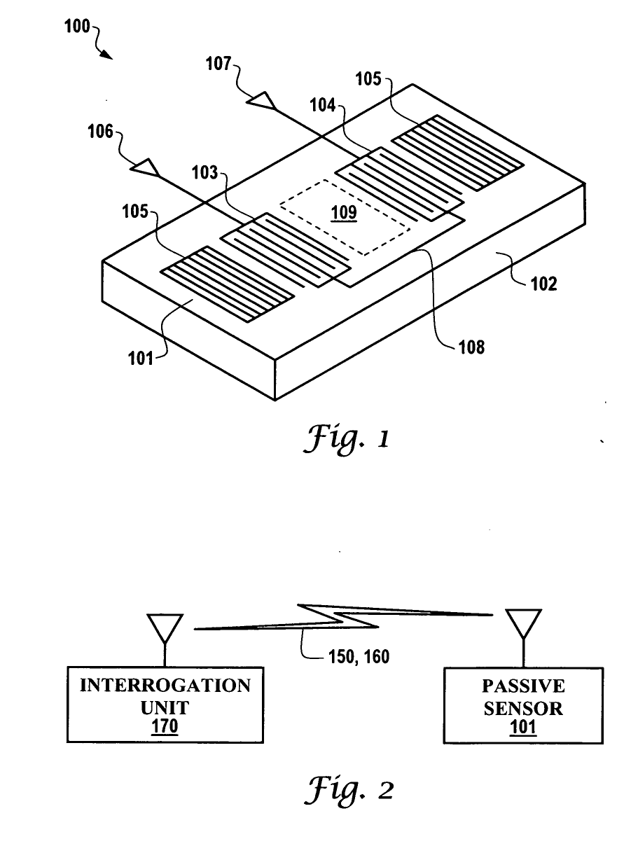

Referring to FIG. 1 of the accompanying drawings, which illustrates a passive acoustic wave pH sensor system having an acoustic wave sensing device which can be implemented in accordance with a preferred embodiment, the sensor system 100 consists of an acoustic wave sensing device 101 having a piezo-electric substrate 102, transducers 103,104, coupled to the substrate, and an antenna 106,107 integrated in the device 101.

By correctly selecting the orientation of the substrate material cut, shear-horizontal surface acoustic waves (SH-SAW) will dominate. These waves have a displacement that is parallel to the device's surface. If the cut of the piezoelectric material is rotated appropriately, the wave propagation mode changes from a vertical shear SAW sensor to a shear-horizontal SAW sensor. This dramatically reduces loss when liquids come into contact with the propagating medium, allowing the SH-SAW sensor to operate in liquids as a chemical or biosensor.

Shear-Horizontal Surface Acoustic Wave (SH-SAW) devices use a piezoelectric substrate with at least one metal interdigital transducer or interdigital electrodes (IDTs or IDEs) deposited on one of the surfaces. Application of an oscillatory voltage to the IDT generates a displacement of the surface. The displacement “wave” will propagate away from the IDT. A key issue for operating surface wave devices in liquids is to generate surface displacements that are shear in direction. Thus, the wave displacement is perpendicular to the direction of wave propagation and in the plane of the crystal surface. The crystal cut of the piezoelectric substrate may be chosen so that application of the electric field by the IDTs produces a shear surface motion.

In this particular embodiment, the sensing device 101 is configured as a two-port SH-SAW resonator having a 36 degree rotated Y-cut crystal substrate, in this case lithium tantalite (LiTaO₃), an input interdigital transducer 103 arranged to transform an interrogation signal into an SH-SAW propagating in the device, and an output interdigital transducer 104 arranged to transform the propagated wave into a response for transmission. Such a configuration is advantageous in that it provides a resonator with a high Q factor and narrow bandwidth. Piezoelectric substrate 102 can be formed from a variety of other substrate materials, such as, for example, quartz, lithium niobate (LiNbO₃), Li₂B₄O₇, GaPO₄, langasite (La₃Ga₅SiO₁₄), ZnO, and/or epitaxially grown nitrides such as Al, Ga or Ln, to name a few. Interdigital transducers can be configured in the form of electrodes. Interdigital transducers 103, 104 can be formed from materials, which are generally divided into three groups. First, interdigital transducers 103,104 can be formed from a metal group material (e.g., Al, Pt, Au, Rh, Ir Cu, Ti, W, Cr, or Ni). Second, interdigital transducers 103, 104 can be formed from alloys such as NiCr or CuAl. Third, interdigital transducers 103,104 can be formed from metal-nonmetal compounds (e.g., ceramic electrodes based on TiN, CoSi₂, or WC).

The IDTs 103,104 are disposed on an upper surface 108 of the substrate 102 and are electrically coupled to respective antennas 106, 107 extending on and away from the substrate 102. The antennas 106, 107 can be, for example, a linear type antenna, or a coupler type antenna depending upon design considerations. In this embodiment, the antennas are 2 half pair antennas and are configured to receive an interrogation signal for the input IDT 103 and transmit the output response of the output IDT 104. Alternatively, other antennas, such as for example loop or slot-type can be used.

The input and output IDTs are each arranged in a 2.5 finger-pair configuration and are located in parallel between a pair of reflectors 105, separated by 20 wavelengths (λ), which reflectors are arranged to reflect at least part of the propagating wave back to a resonator cavity located between the input and output IDTs 103, 104. In this case, each reflector consists of about 200 reflecting members, such as aluminum stripes, and each member is 40 λ in length. The center frequency of the device is about 40 MHz.

An electrically open surface of the substrate located in the path of the propagating wave in the cavity region forms an interactive region 109 such that a liquid disposed at or adjacent to the interactive region can interact acousto-electrically with the propagating wave. The liquid can be contained in a chamber placed in the interactive region or alternatively can be in direct contact with the substrate surface in the interactive region. In this case, the liquid under analysis is oil and the sensing device is designed to be placed in direct contact with the oil (not shown). The IDTs 103, 104, and reflectors 105 are coated with a thin insulating film, such as for example a 50A amstrong thick layer of aluminum oxide (Al₂O₃), in order to protect them from the oil or other liquid.

The sensing device 101 is arranged such that an interrogation signal is transformed by the input transducer 103 into a shear-horizontal acoustic wave (SH-SAW) which propagates on the substrate surface 108 in the interactive region 109 and which has an electric field which extends several micrometers into the adjacent liquid and is able to interact with ions in the liquid. This type of interaction, known as acousto electric interaction, is determined by the dielectric constants and other electrical properties of the liquid and substrate, including the conductivity of the liquid, and causes changes in the SH-SAW velocity and attenuation of the wave. The SH-SAW and other types of acoustic waves having a shear-horizontal modes such as for example shear-horizontal acoustic plate mode (SH-APM), flexural plate mode (FPM) also known as Lamb wave, and Love wave, are examples of types of waves which have a surface component sufficient to provide the necessary acousto-electric interaction. Changes to the wave caused by the acousto-electric interaction are sensed by the output IDT 104 and a response of the output IDT is transmitted by the antenna 107 for remote analysis of these changes to evaluate the conductivity, pH or other electrical properties of the ionique liquid.

Referring to FIG. 2, which illustrates the principle of operating the passive acoustic wave pH sensor system of FIG. 1 using an interrogation unit, the passive acoustic sensor system 100 is adapted and arranged to receive an interrogation signal 160 from an interrogation unit 170 and to transmit an output response 150 to the interrogation unit 170 to enable remote sensing of electrical properties of a liquid at or adjacent the interactive region 109 of the sensing device 101. The interrogation signal 160 can be a high frequency electromagnetic wave, such as an RF signal.

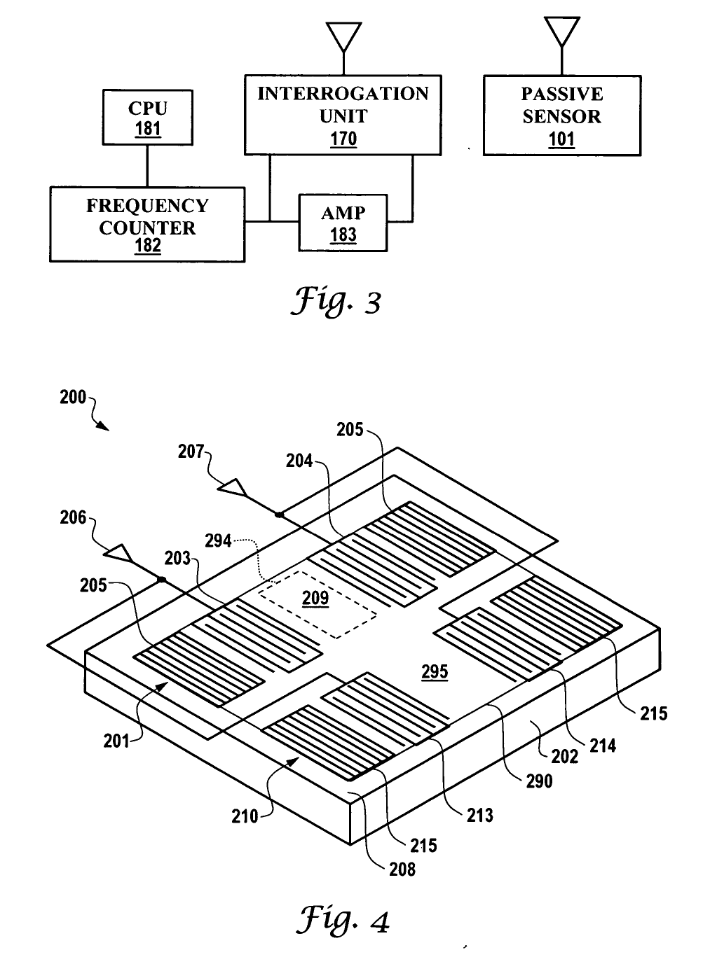

Changes in SAW velocity caused by interaction between the liquid and propagating wave can be monitored by measuring the RF frequency of a stabilized oscillator formed by placing the sensing device 101 in the feedback loop of an amplifier, for example as shown in FIG. 3, which illustrates a typical oscillation circuit including an amplifier and processing circuitry for analyzing the sensing device output response. The processing circuitry 181,182 consists of a frequency counter 181 and a computer processor unit (CPU) 182 electrically coupled to the amplifier 183. The interrogation unit or reader 170 interfaces the amplifier 183 and processing circuitry 181,182 to the sensing device. The interrogation unit 181, processing and other circuitry 181,182,183 could, for example, be arranged in a control module of a vehicle.

Interrogation techniques similar to those employed in radar applications can be used to transmit the interrogation signal and detect the output response. In this embodiment, the interrogation unit 170 includes electronics for gating the received response 150 in the time domain to differentiate between the interrogation signal 160 and the response 150 in order to remove environmental echoes. The resulting peaks in the frequency domain after performing a Fourier transform are analyzed to extract the sensing device output response.

A method of operating the passive acoustic wave pH sensor system 100 to remotely measure the conductivity, pH or other electrical properties of oil or other liquid will now be described with reference to FIGS. 1-3 of the accompanying drawings. Initially, the interrogation unit 170 generates an interrogation signal 160 and transmits this signal to the sensing device 101 which is remotely located in contact with the oil under analysis. The antenna 106 receives the interrogation signal 160 and the input IDT 103 transforms the signal into a SH-SAW which propagates on the substrate surface 108.

The oil interacts acousto-electrically with the wave propagating in the interactive region 109 and thereby changes the frequency, phase and other propagation characteristics of the wave. The output IDT 104 transforms the changed propagating wave into a response 150 which is transmitted by the antenna 107 to the interrogation unit 170. The sensing device response is extracted by the interrogation unit and changes in the oscillation frequency are measured and then analyzed by the processing circuitry 181,182 to evaluate the conductivity, pH or other electrical properties of the liquid.

Referring now to FIG. 4, which illustrates a passive acoustic sensor system having a sensing device and reference device in accordance with a second embodiment, the passive entry sensor system 200, which can be utilized to measure the electrical properties of the liquid with greater accuracy, has a sensing device 201 constructed in a similar manner to the sensing device 101 of the first embodiment save that a conductive layer 290, such as a metal layer, is disposed on the substrate upper surface 208 extending between the input and output IDTs 203, 204 and reflectors 205 such that an acousto-electric interactive region 209 is defined by a portion of the substrate surface 208 which is left electrically open by an opening 294 formed in the conductive layer. The sensing device 201 is arranged such that the output IDT 204 detects changes in the SH-SAW caused by acousto-electric perturbations between the liquid and the wave propagating in the interactive region 209 and mechanical perturbations between the liquid and the conductive layer 290.

A reference device 210 is constructed on the substrate upper surface 208 in parallel with and spaced from the sensing device 201. The reference device is similar in construction to the sensing device with the critical exception that the conductive layer 290 entirely covers the substrate surface between the reference device IDTs 213,214 and reflectors 215 such that the conductive layer forms an electrically closed reference region 295.

Since the conductivity of the conductive layer 290 is equivalent to infinity, the electric potential at the interface of the reference region becomes zero such that a reference SH-SAW propagating through the reference device 210 is only perturbed by the mechanical properties of the liquid in contact with the reference region 295 and is unaffected by acousto-electric effects of the liquid. The IDTs 203, 204, 213, 214 and reflectors 205,215 are coated with a thin layer of insulating material to protect them from contacting the liquid, as in the case of the device of the first embodiment.

The reference device 210 can reply to the interrogation signal 160 by transmitting a response in which mechanical interactions of the liquid with the reference wave are measurable to evaluate the mechanical effects of the liquid on the reference wave. When liquid is in contact with the conductive layer 290 and the interactive region 209, the sensing and reference devices can reply to the interrogation signal 160 by transmitting responses 150 in which changes in frequency, phase or other propagation characteristics caused by the acousto-electrically effects of the liquid are separable from changes caused by mechanical effects of the liquid to enable the conductivity, pH or other electrical properties of the liquid to be evaluated.

In this particular embodiment, the outputs responses of the sensing and reference devices 201, 210 are mixed together such that changes in the wave propagation characteristics of each device caused by mechanical effects of the liquid cancel one another leaving only changes caused by the acousto-electric effects of the liquid. Oscillator circuits can be formed by placing the sensing and reference devices in feedback loops of amplifiers and the oscillation frequency can be measured using the same interrogation and processing circuitry shown in FIG. 2. By using a reference device 210 in conjunction with the sensing device 201, the passive sensor system of the second embodiment can more accurately sense electrical properties of oil and other liquids, especially when the liquids are in high concentration and so the mechanical effects of the liquid are more pronounced.

A method of operating the passive acoustic wave sensor system according to the second embodiment to remotely measure the conductivity, pH or other electrical properties of oil or other liquid will now be described. Initially, the interrogation unit 170 generates an interrogation signal 160 and transmits this signal to the sensing device 201 and reference device 210 which are remotely located in contact with the oil. The input IDT 203 transforms the signal received by the antenna 206 into a sensing SH-SAW and the input IDT 213 transforms the signal into a reference SH-SAW. The liquid interacts both acousto-electrically and mechanically with the propagating sensing SH-SAW and only mechanically with the propagating reference SH-SAW.

The output IDTs 204, 214 transform the sensing and reference SH-SAWs respectively into responses which are transmitted by the antenna 207 to the interrogation unit 170. Mixing the responses effectively cancels changes to the sensing SH-SAW caused by mechanical effects of the liquid such that the resulting response 150 only represents changes to the sensing SH-SAW caused by the acousto-electric effects of the liquid. The resulting response is extracted by the interrogation unit and changes in the oscillation frequency are measured and then analyzed by the processing circuitry to evaluate the conductivity, pH or other electrical properties of the liquid.

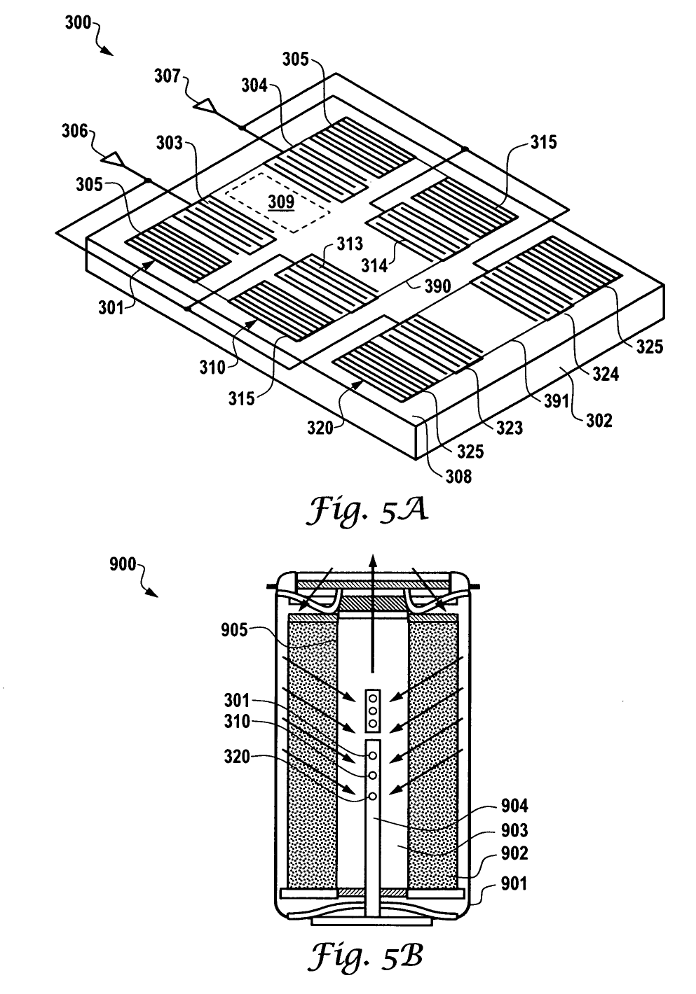

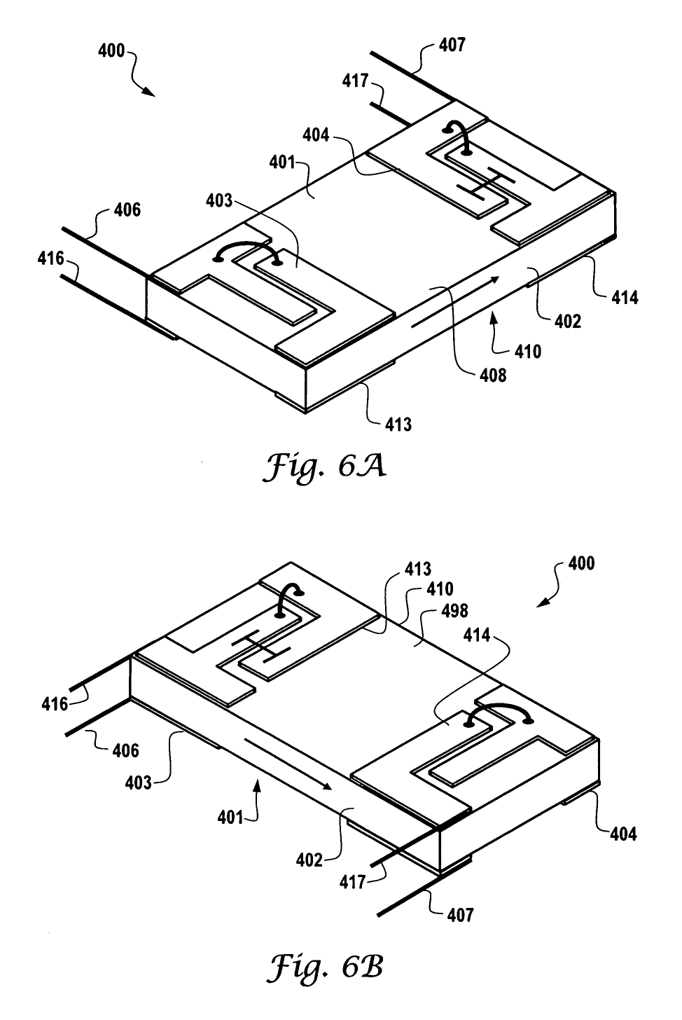

Referring to FIG. 5(a), which illustrates a passive sensor system having a sensing device and a pair of reference devices according to a third embodiment, a pair of reference devices 310, 320 are utilized to enable temperature or other environmental effects which influence the oscillation frequency of the devices to be monitored allowing temperature or other environmental compensation of the measurements of changes in frequency caused by the acousto-electric and/or the mechanical effects of the liquid. In this particular embodiment, the reference devices 310, 320 are for providing temperature compensation.

Each of the reference devices is similar to the reference device 210 of the second embodiment and each forms an oscillation loop with an amplifier. However, since the temperature coefficient of the SAW velocity is dependent on the propagation direction on the substrate, the reference devices have a specific angle arrangement and topology such that the reference devices oscillate on slightly different center frequencies which have different temperature dependence. The difference of the frequency outputs of the reference devices 310,310 can be measured to determine the temperature influence on the measurements of changes in wave propagation due to the mechanical effects of the liquid and, in turn, compensate the measurements of the conductivity, pH or other electrical property measurements of the liquid.

In this particular embodiment, the passive acoustic wave sensor system 300 can be arranged inside a vehicle oil filter system as shown in FIG. 5(b) for monitoring the vehicle engine oil quality. In this case, the substrate 302 has a low concentration of defects making the substrate mechanically stronger and more resistant to thermal-shock, etc. To achieve this, the substrate is fabricated from swept quartz using a double-side polished wafer and the edges of the die are polished mechanically or chemically to reduce micro-crack propagation in the substrate.

The oil filter system 900 includes a filter can 901, a filter media 902 and a channel 905 through which engine oil 903 can flow. The sensing device 301 and reference devices 310, 320 are mounted inside the channel on a post 904 extending longitudinally of the channel from the exterior of one end of the filter can into the interior of the can. The antennas of the devices (not shown) extend to locations on the post at the exterior of the filter can. The interrogation unit and processing circuitry (not shown) are located within a control module of the vehicle.

The method of operating the passive sensor system according to the third embodiment will now be described with reference to FIGS. 5(a) & 5(b). Initially, the interrogation unit, 170 generates an interrogation signal 150 and transmits this signal to the sensing device 301 and reference devices 310, 320 which are remotely located in contact with the liquid under analysis, in this case, engine oil 903 contained in the oil filter system 900. The input IDTs 303, 313, 323 transform the signal received by the antenna 306 into sensing and reference SH-SAW waves. The oil flowing in the channel 905 interacts both acousto-electrically and mechanically with the propagating sensing wave and only mechanically with the propagating reference waves.

The output IDTs 305, 315 325 transform the propagating sensing and reference SH-SAWs into responses which are transmitted to the interrogation unit. The resulting responses are extracted by the interrogation unit and analyzed by the processing circuitry to determine changes in the oscillation frequency of each oscillation circuit associated with each device caused by acousto-electric effects of the liquid, mechanical effects of the liquid, and temperature effects. Changes caused by the temperature effects can be determined by measuring the difference in oscillation frequencies of the reference devices 315, 323 which then enables temperature compensation of the measurements of the mechanical effects and/or conductivity, pH or other electrical properties of the oil.

Referring to FIGS. 6(a) & 6(b), which illustrate front and rear perspective views of a passive sensor system having shear-horizontal Acoustic Plate Mode (SH-APM) sensing and reference devices according to a fourth embodiment, the sensing device is configured as a two-port SH-APM resonator having a quartz plate substrate 402, an input IDT 403 arranged on the top side of the substrate to transform the interrogation signal into an APM propagating sensing wave and an output IDT 404, spaced apart from the input IDT 403, arranged to transform the propagating wave into an output response.

Antennas 406, 407 are electrically coupled to the IDTs 403,404 for receiving the interrogation signal and transmitting the output response. The electrically open top surface 408 of the substrate between the IDTs 403,404 forms the interactive region. Since the APM waves travel between the top and bottom substrate surfaces 408, 498, the reference device 410 can be arranged either on the top or bottom surface to detect the mechanical effects of the liquid in contact with the top surface 408 of the substrate. In this particular case, the reference device 401 is formed on the bottom surface 498 of the substrate 402 and consists of input and output IDTs 413,414, arranged spaced apart in a similar manner to the IDTs 403, 404 of the sensing device, and antennas 416, 417 electrically coupled to the IDTs.

Arranging the reference device 401 on the bottom surface 498 of the substrate is advantageous in that the substrate can protect the reference region between the IDTs 413, 414 from liquid in contact with the sensing device 401 on the top surface of the substrate such that acousto-electric interactions between the reference region and the liquid cannot occur. Conductive layers are therefore not necessary for eliminating the acousto-electric effects of the liquid.

SH-APM can use thin quartz plates that serve as acoustic wave-guides, confining acoustic energy between the upper and lower surfaces of the plate as a wave propagates between input and output transducers unlike in a SAW device in which almost all acoustic energy is concentrated within the wavelength of the surface. The consequences of this difference are that the sensitivity of the SH-APM to mass loading and other perturbations depends on the thickness of the quartz. Both surfaces of the device undergo displacement, so the detection can occur on either surface of the device.

The method of operating the passive sensor system 400 of the fourth embodiment is similar to the method of operating the sensor system 300 of the third embodiment. Initially, the interrogation unit generates an interrogation signal and transmits this signal to the sensing device 401 and reference device 410 but, unlike in previous embodiments, only the sensing device is in contact with the liquid under analysis and the reference device is protected from the liquid by the substrate 402. The input IDTs 403, 413 transform the interrogation signal into sensing and reference SH-APM waves. The liquid interacts both acousto-electrically and mechanically with the propagating sensing wave on the top surface 408 of the substrate but only mechanically with the reference wave propagating on the bottom surface 498 of the substrate. As in the case of previous embodiments, the output responses of the devices 401, 410 are transmitted to the interrogation unit, the resulting responses are mixed together to isolate the changes in the oscillation frequency of the sensing device caused only by the acousto-electric effects of the liquid and analyzed by the processing circuitry to measure the conductivity, pH or other electrical properties of the liquid.

In alternative embodiments, more than one reference device can be used on the bottom of the substrate to enable temperature compensation of the measurements (not shown). A reference layer can be disposed between the IDTs of one of the reference devices or different reference layers can be disposed on the reference devices such that the reference propagating waves have different temperature dependence which enable the measurements of the electrical properties to be temperature compensated in the same manner as the measurements using the passive sensor system of the third embodiment are compensated. The reference layers need not be conductive layers when the reference sensing devices are formed on the bottom surface of the substrate.

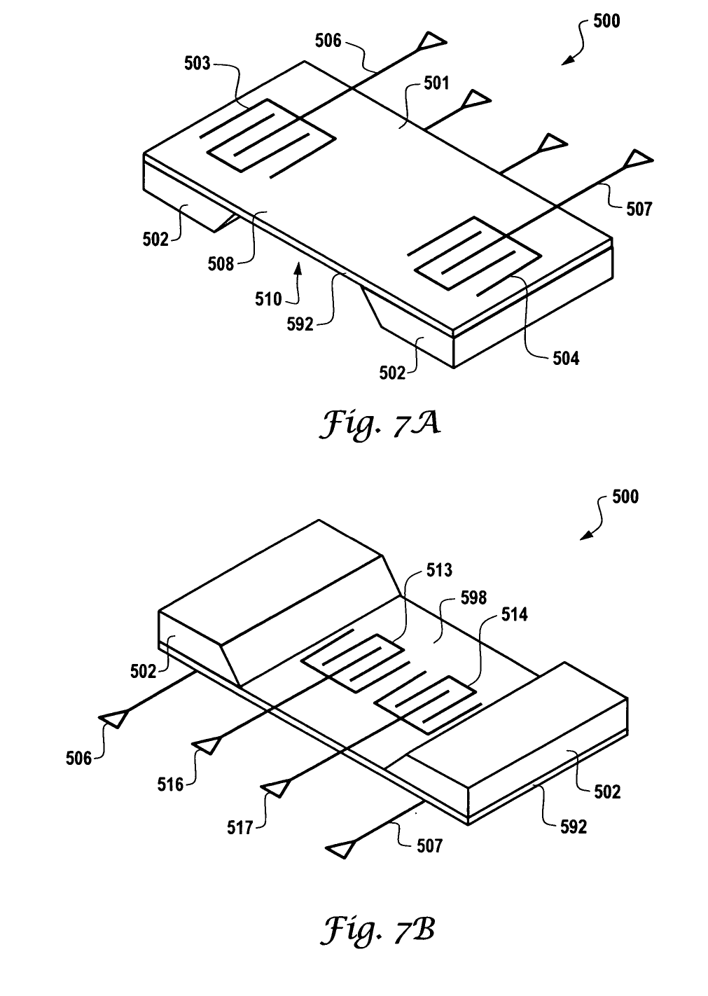

Referring to FIGS. 7(a) & 7(b), which illustrate front and rear perspective views of a passive sensor system having FPM sensing and reference devices in accordance with another embodiment, the sensing device 501 can be configured as a two-port FPM resonator in which the input and output IDTs 503, 504 are formed on a piezoelectric membrane 592 which membrane is supported at its free ends by silicon substrates 502. The input and output IDTs are arranged to transform the interrogation signal into an FPM acoustic sensing wave and transform the propagating sensing wave into an output response. Antennas 506, 507 are electrically coupled to the IDTs 503, 504. The interactive region consists of the electrical open upper surface 508 of the membrane between the IDTs. A reference device can be used on the top or bottom surface of the membrane.

In this embodiment, the reference device 510 is formed on the bottom surface 598 of the membrane to protect the device 510 from liquid in contact with the sensing device, in the same way that the substrate 402 protects the reference device 410 in the previous embodiment. Also, as in the case of the APM resonator configuration, at least two reference devices can be formed on the bottom surface with different reference layers having different temperature dependence to enable temperature compensation of the conductivity measurements. The method of operating the FPM sensing and reference devices to measure conductivity of the liquid and compensate for temperature effects is similar to the method of operating the passive sensor system having the APM resonator sensing and reference devices.

A number of advantages can be obtained through the use of FPW devices. For example, the detection sensitivity is not based on frequency of operation like other acoustic devices, but instead on the relative magnitude of the perturbation to a parameter of the membrane. In the case of mass, the sensitivity is the ratio of the added mass to the membrane mass. Since very thin (low mass) membranes can be created, the detection sensitivities can be very large, much larger than other acoustic sensor modes. Frequencies of operation are in 100's of kHz to few MHz range. The low operating frequency leads to simple electronic circuits to drive and detect sensor signals.

Since the FPW devices are made on silicon wafers, large arrays of the devices can be fabricated on single substrates and all of the drive and detection electronics can be integrated onto the same substrate. For large scale sensor system integration, the FPW devices are one of the only acoustic technologies available. The antibody films and fluids for bio-sensing contact the etched silicon side of the device. This provides a natural fluid barrier to protect the metals and other electronics that are placed on the far surface. Integrated silicon electronic devices can be very low cost and are easily packaged.

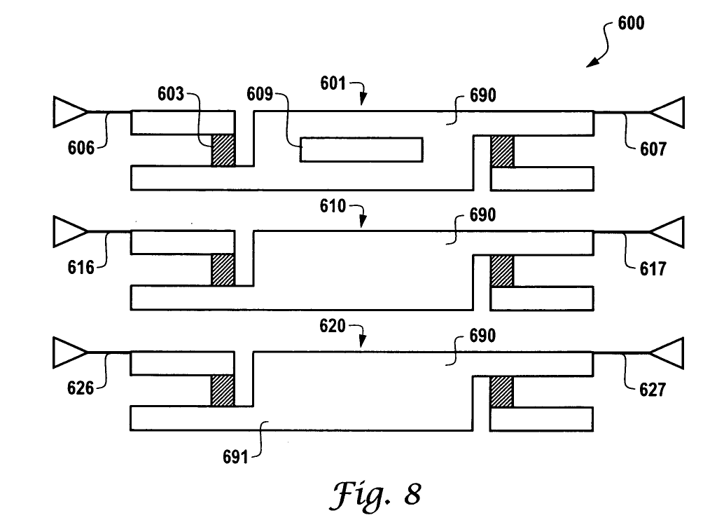

Referring to FIG. 8, which illustrate a plan view of a passive sensor system having a sensing and reference devices configured as delay-line devices according to yet another embodiment, the passive sensor system can include sensing and reference devices each configured as a two-port delay line SH-SAW devices. Each device has an input IDT for transforming the interrogation signal into a SH-SAW wave and an output IDT for transforming the propagating wave into an output response. The input and output IDTs of each device are spaced apart opposing one another forming delay lines. Antennas are electrically coupled to the IDTs. In this particular embodiment, the passive sensor system 600 includes a sensing device 601 and two reference devices 610,620 formed on a 36 degree rotated Y-cut crystal substrate, in this case LiTaO₃. As in the case of the second embodiment, the interactive region 609 of the sensing device is formed by a conductive layer 690 having an opening formed therein exposing an electrically open surface of the substrate and the reference devices include conductive layers 690,691 forming electrically closed surfaces. The output responses are transmitted to the interrogation unit which extracts the response for analysis. Changes in the phase of the propagation techniques can be monitored to determine changes in the phase characteristics of the propagating waves caused by the acousto-electrical and mechanical effects of the liquid and temperature effects.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims.

For example, the skilled person would understand that interrogation techniques other than those described herein with reference to the embodiments can be utilized, such as for example, time domain sampling using pulse radar, chirp radar designs or frequency domain radar using an FMCW or network analyzer structure designs.

Additionally, the skilled person would understand that techniques for measuring the change in velocity of the propagating wave other than those described herein with reference to the embodiments can be utilized, such as for example, direct phase measurement, which involves directly comparing the transfer phase to some reference phase, or a sing around arrangement which involves measuring a pulse rate obtained when a pulse detector at the output IDT of a delay line triggers the next pulse at the input IDT.

Furthermore, whilst a SH-SAW, APM and FPM wave modes are utilized as the propagating wave in the described embodiments, the skilled person would understand that any type of acoustic wave may be used which has a surface component sufficient to allow acousto-electric interaction With the adjacent liquid.

It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. An acoustic wave sensor system comprising:
an acoustic wave sensing device having
a piezoelectric substrate,
an antenna integrated in said sensing device,
one or more transducers, coupled to said substrate and said antenna, said transducer(s) being adapted and arranged to transform an interrogation signal, received by said antenna, into an acoustic wave propagating in said device and to transform the propagated wave into a response for transmission by said antenna, and
an interactive region having an electrically open surface arranged in a path of the wave such that a liquid disposed at or adjacent to said interactive region can interact acousto-electrically with said propagating wave, and
whereby said sensing device, in reply to said interrogation signal, can transmit a response in which changes in frequency, phase or other propagation characteristics of said wave caused by said liquid acousto electric interaction can be analyzed to evaluate the conductivity, pH or other electrical properties of the liquid.

2. The sensor system of claim 1, wherein said sensing device includes at least one reflector for reflecting at least part of the propagating wave to at least one transducer.

3. The sensor system of claim 2, wherein said sensing device is configured as a resonator and wherein said interactive region is formed in a cavity or resonating region of said resonator.

4. The sensor system of claim 3, wherein said sensing device is configured as a two-port resonator or a filter having an input interdigital transducer (IDT) for transforming the interrogation signal and an output IDT for transforming the acoustic wave, said IDTs being electrically coupled to said antenna and disposed between a pair of said reflectors, and wherein said interactive region comprises an electrically open substrate surface between said input and output IDTs.

5. The sensor system of claim 1, wherein said sensing device is configured as a two-port delay line device having an input IDT for transforming the interrogation signal and an output IDT for transforming the acoustic wave, said IDTs being electrically coupled to said antenna, and wherein said interactive region comprises an electrically open surface of said substrate between said input and output IDTs.

6. The sensor system of claim 1, wherein the sensing device is configured such that the interrogation signal is transformed by the transducer(s) into an acoustic wave having a shear-horizontal type mode or other wave mode type having a surface component such that the liquid interacts acousto-electrically with the wave.

7. The sensor system of claim 1, wherein the sensing device is configured such that the interrogation signal is transformed by the transducer(s) into an acoustic wave having at least one of the following modes: a shear horizontal acoustic wave mode (SH-SAW), a shear-horizontal acoustic plate mode (SH-APM), a flexural plate mode (FPM) also known as Lamb wave, and Love wave.

8. The sensor system of claim 1, including an interrogation unit for transmitting the interrogation signal to said antenna and for receiving the output response of said sensing device transmitted by said antenna.

9. The sensor system of claim 8, wherein said interrogation unit includes circuitry for gating the received response in the time domain such that the response is separable from the interrogation signal and environmental echoes.

10. The sensor system of claim 9, including an oscillator circuit coupled to said interrogation unit, said sensing device forming part of a feedback loop of said oscillator circuit, and including a frequency counter and processor connected to said oscillator circuit for measuring changes in the oscillation frequency or transient response caused by said sensing device.

11. An acoustic wave sensor system comprising:
an acoustic wave sensing device having
a piezoelectric substrate,
an antenna integrated in said sensing device,
one or more transducers, coupled to said substrate and said antenna, said transducer(s) being adapted and arranged to transform an interrogation signal, received by said antenna, into an acoustic sensing wave propagating in said device and to transform the propagated wave into a response for transmission by said antenna, and
an interactive region having an electrically open surface arranged in a path of the wave such that a liquid disposed at or adjacent said interactive region can interact acousto-electrically and mechanically with said propagating sensing wave, said sensing device, in reply to said interrogation signal, transmitting a response including changes in frequency, phase or other propagation characteristics of said wave caused by said acoustic-electric interactions and said mechanical interactions, and
at least one acoustic wave reference device, each reference device comprising:
one or more transducers, coupled to said substrate and said antenna, said transducer(s) being adapted and arranged to transform an interrogation signal, received by said antenna, into an acoustic reference wave propagating in said reference device and to transform the propagated reference wave into a response for transmission by said antenna, and
a reference region arranged in a path of the wave such that a liquid disposed at or adjacent said reference region causes only mechanical interactions with said propagating reference wave, each reference device, in reply to said interrogation signal, transmitting a response including changes in frequency, phase or other propagation characteristics of said reference wave(s) caused by said mechanical interactions, and
whereby, when said liquid is disposed at or adjacent both said interactive region and said reference region(s), said responses of said sensing device and said reference device(s) are mixable to isolate changes in said propagation characteristics caused by said acousto-electric interactions for analysis thereof to evaluate the conductivity, pH or other electrical properties of the liquid.

12. The sensor system of claim 11, wherein said sensing device and each reference device are formed on the same side of said substrate.

13. The sensor system of claim 11, wherein said sensing device includes a conductive layer disposed on said substrate and wherein said interactive region comprises an electrically open surface defined by an opening formed in said conductive layer.

14. The sensor of claim 11, wherein each reference device includes a conductive layer formed on said substrate and wherein said reference region comprise an electrically closed surface formed by said reference device conductive layer.

15. The sensor of claim 11, wherein each reference device is formed on an opposite side of the substrate to the sensing device whereby the sensing device is arranged to contact or be in close proximity with the liquid and whereby said substrate isolates said reference device(s) from said liquid.

16. The sensor of claim 15, wherein said sensing device includes a layer of material disposed on said substrate, said interactive region comprising an open surface of the substrate formed by an opening defined in said layer of material, and wherein each reference device includes a layer of material disposed on said substrate, said reference region comprising the surface of said layer.

17. The sensor system of claim 11, including a pair of said reference devices arranged at an angle relative to one another such that the acoustic wave propagation characteristics of said reference devices have differing temperature or other environmental dependence, whereby in reply to said interrogation signal said reference devices can transmit responses in which changes in the propagating wave characteristics caused by temperature or other environmental effects are separable from changes caused by said mechanical effects to enable temperature or other environmental compensation of the measurements of said mechanical effects of said liquid and allow temperature or other environmental compensation of the measurements of the conductivity, pH or other electrical properties of the liquid.

18. A method of remotely sensing the conductivity, pH or other electrical properties of a liquid comprising the steps of:
generating an interrogation signal,
transmitting said interrogation signal,
receiving said interrogation signal,
transforming said received interrogation signal into a propagating acoustic sensing wave,
acousto-electrically interacting a liquid with said propagating sensing wave,
transforming said propagating wave into a sensing response,
transmitting said sensing response,
measuring changes in the propagation characteristics of the sensing wave caused by said acousto-electric interactions,
analyzing said changes in said propagation characteristics to evaluate the conductivity, pH or other electrical properties of the liquid.

19. A method of claim 19, further comprising the steps of:
mechanically interacting said liquid with said propagating sensing wave,
transforming said received interrogation signal into a first propagating acoustic reference wave,
mechanically interacting said liquid with said first propagating reference wave,
transforming said propagating first reference wave into a first reference response,
transmitting said first reference response, and
mixing said sensing response and said reference response to isolate changes to said sensing wave propagation characteristics caused by said acousto electric interactions of said liquid.

20. A method of claim 19, further comprising the steps of:
transforming said received interrogation signal into a second propagating acoustic reference wave having a different temperature dependence to said first reference wave,
mechanically interacting said liquid with said second propagating reference wave,
transforming said second propagating reference wave into a second reference response,
transmitting said second reference response,
analyzing said first and second reference responses to determine the temperature effects on measuring said reference waves and said sensing waves, and
temperature compensating measurements of said mechanical effects and said acousto-electric effects.
